(19) United States
(12) Patent Application Publication
(10) Pub. No.: US 2025/0084697 A1
(43) Pub. Date: Mar. 13, 2025

(54) Stairway for an Inflatable Structure

(71) Applicant: IP Holdings FL LLC., Orlando, FL (US)

(72) Inventor: Kevin Cook, Sorrento, FL (US)

(21) Appl. No.: 18/367,411

(22) Filed: Sep. 12, 2023

(51) Int. Cl. E06C 1/34; A63G 31/00

(52) U.S. Cl. CPC E06C 1/34; A63G 31/00

(57) ABSTRACT

The stairway includes a stairway backing, a plurality of paired step anchors affixed to the stairway backing, and a plurality of detachable step members secured between the paired step anchors. The step anchors are affixed to the stairway backing and are spaced vertically apart from one another and paired together to form top and bottom anchors for detachably securing the step members. Each step anchor has an anchor base, which is sewn or bonded directly to the stairway backing and an anchor flap, which is adapted and constructed to fold over the anchor base. The outer face of the anchor bases and anchor flaps are covered in hook and loop fastener material. The replaceable step members form the steps or rungs of the stairway. Each step member has a main body and pair of opposed step flanges covered with hook and loop fastener material for mating to the hook and loop fastener material of the step anchors. The step flanges are interposed between the anchor base and the anchor flaps, which folds back over the anchor base.

This invention relates to a stairway for inflatable structures, such as inflatable fun houses and slides, and in particular a stairway that allows individual steps or rungs to be replaced and/or repaired without replacing the entire stairway.

### BACKGROUND OF THE INVENTION

Inflatable structures, such as inflatable fun houses and slides, are constructed from sheets and strips of thermoplastic covered fabrics sewn and fused together to form the walls and sections of the structure, which are then inflated by fans and blowers. The cavity between the layers of fabric is pressurized with air to produce a rigid structural element. Sewn joints and seams of all inflatable structures leak or “bleed” air. High-volume fans or blowers replace the air that is bled through the sewn seams.

Inflatable slides includes inflatable stairways that allow users to ascend to the top of the slide before descending down the inflatable slide ramps. These stairways are generally integrated directly into the structure of the inflatable slide. Inflatable stairways have raised thermoplastic covered foam steps or ladder rungs that are sewn to an elongated sheet of thermoplastic fabric which forms the back of the stairway. Inflatable stairways in inflatable slides are high traffic areas and the raised steps and rungs are prone to wear and damage. Because stairways are generally integrated directly into the structure of the inflatable slide, repairing or replacing the steps or rungs of the stairway requires unstitching multiple critical seams of the inflatable slide and replacing slide backing along with each step or rung. Consequently, the repair or replacement of individual steps or rungs is as costly as repairing or replacing an entire stairway.

### SUMMARY OF INVENTION

The present invention provides a stairway for inflatable structures that allows individual steps or rungs to be replaced and/or repaired without replacing the entire stairway. The stairway includes a stairway backing, a plurality of paired step anchors affixed to the stairway backing, and a plurality of detachable step members secured between the paired step anchors. The step anchors are affixed to the stairway backing and are spaced vertical apart from one another and paired together to form a top and bottom anchor for detachably securing the step members. Each step anchor has an anchor base, which sewn or bonded directly to the stairway backing and an anchor flap, which is adapted and constructed to fold over the anchor base. The outer face of the anchor bases and anchor flaps are covered in hook and loop fastener material. The replaceable step members form the steps or rungs of the stairway. Each step member has a main body and pair of opposed step flanges covered with hook and loop fastener material for mating to the hook and loop fastener material of the step anchors. The step flanges are interposed between the anchor base and the anchor flaps, which fold back over the anchor base. The mating hook and loop fastener materials on both sides of the step flanges and the step anchors securely hold the step members to the stairway backing. In addition, the hook and loop engagement between the step members and the step anchors allows the step members to be readily detached from the stairway backing.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a perspective view of an exemplary inflatable slide using the stairway of this invention;

FIG. 2 is a partial exploded view of the stairway of FIG. 1 separated from the slide;

FIG. 3 is a perspective view with a portion cutaway of one of the removable step members of the stairway assembly of FIG. 1;

FIG. 4 is a partial perspective view of the stairway of FIG. 1 showing a step member spaced from the paired step anchors;

FIG. 5 is a partial perspective view of the stairway of FIG. 1 showing a step member secured to the stairway backing between the paired step anchors; and

FIG. 6 is a partial side sectional view of a step anchor securing a step member to the stairway backing.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural and mechanical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

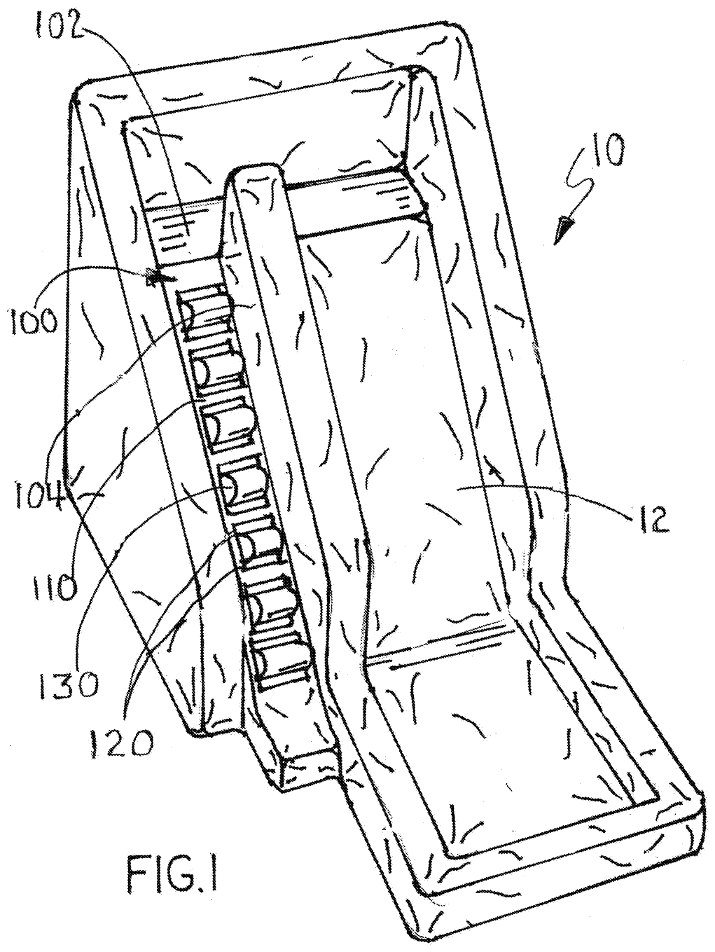

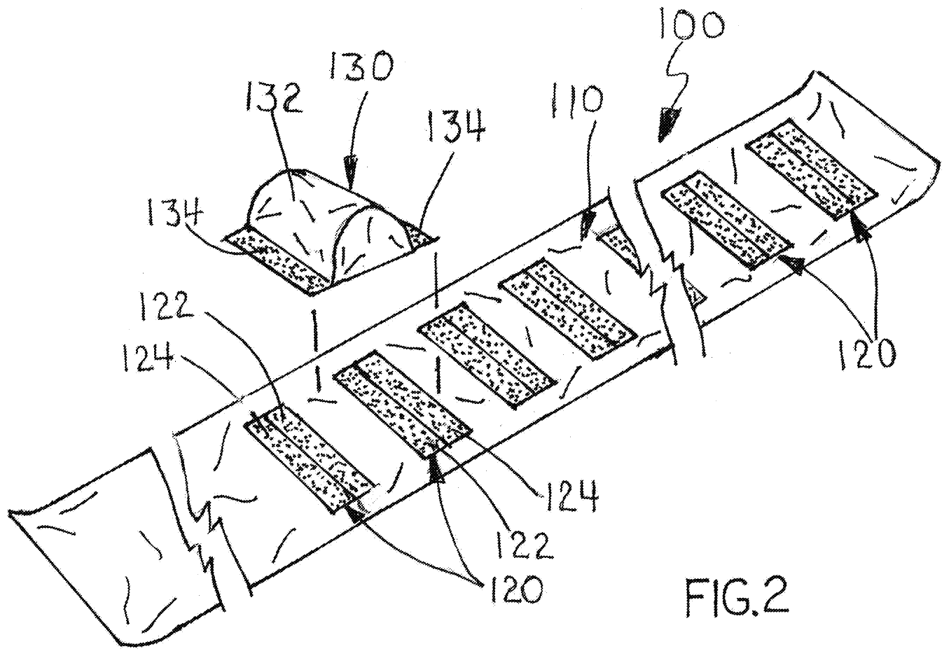

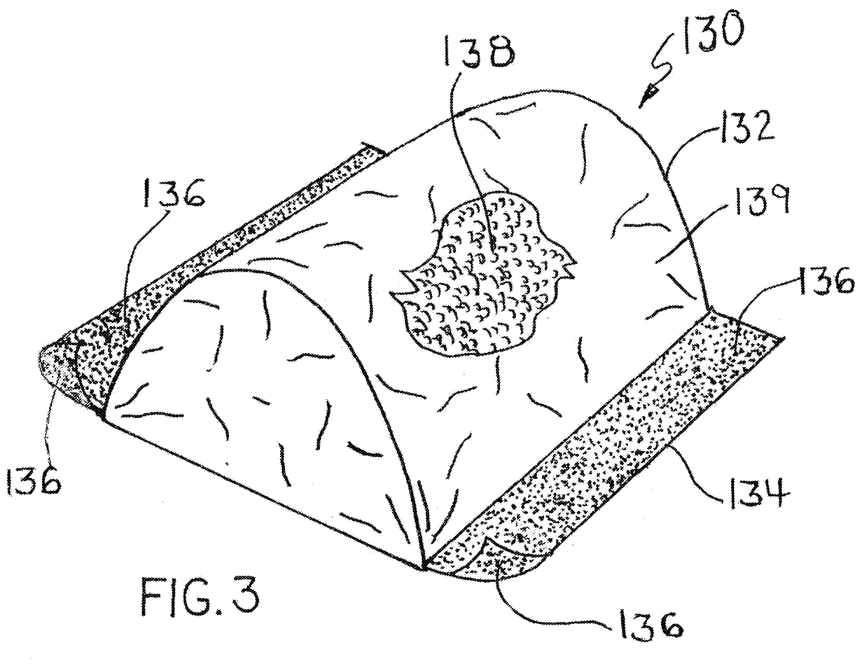

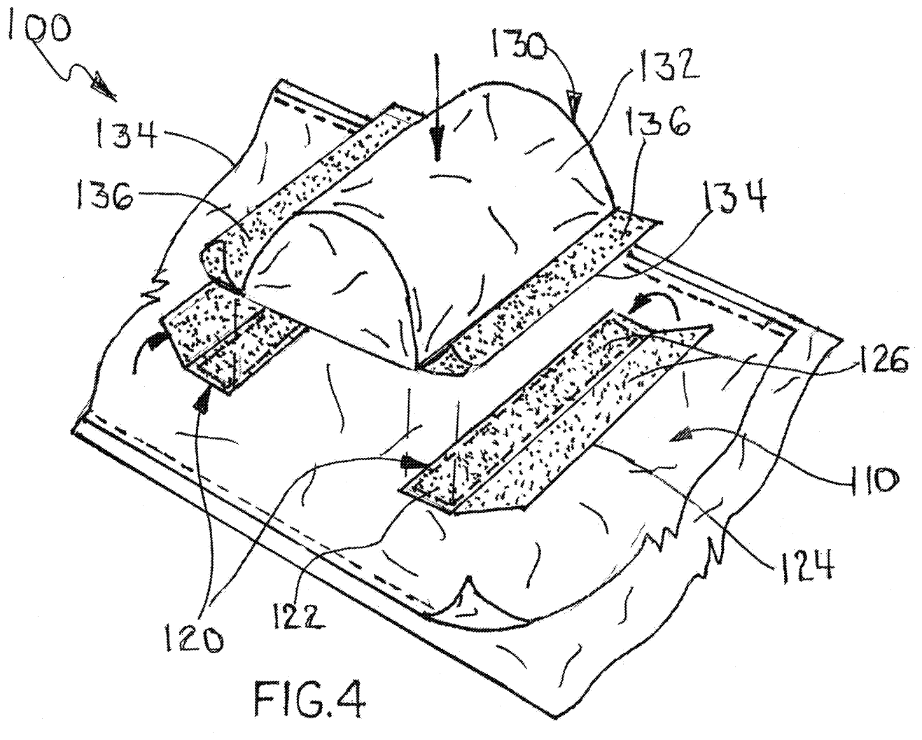

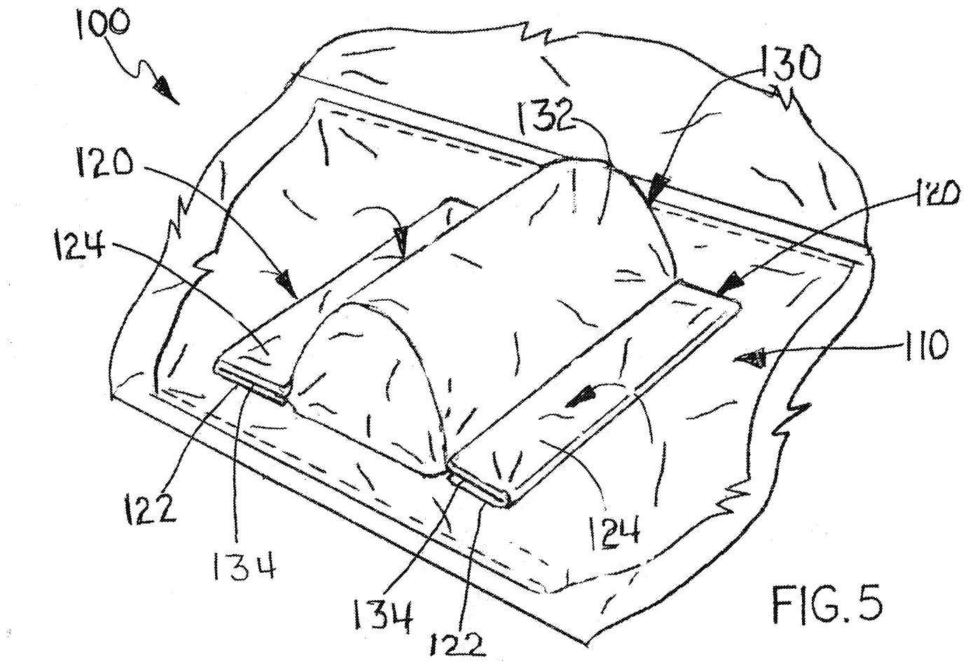

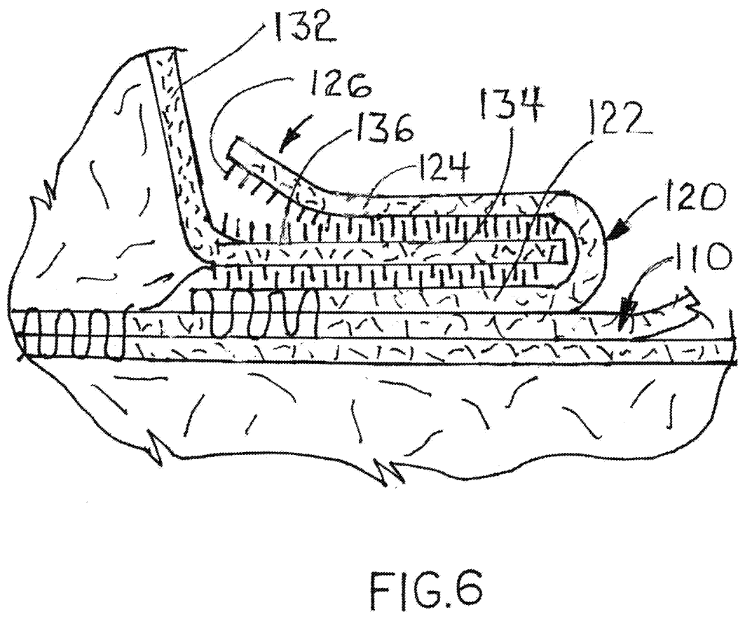

Referring now to the drawings, FIGS. 1-6 illustrate the replaceable stairway of this invention, which is designated generally as reference numeral 100, used in a conventional inflatable slide 10. Inflatable slide 10 is constructed from sheets of thermoplastic covered fabrics, such as a “PVC” coated woven nylon cloth, using conventional inflatable methods. Blowers (not shown) provides a constant airflow that inflates and maintains the structural integrity of slide 10.

Stairway assembly 100 allows users to easily ascend to the top of slide 10 before descending down the slide runway 12. As shown, stairway 100 is an integral part of slide 10. In other embodiments, stairway 100 can be a separate inflatable structure joined or positioned adjacent the slide. Stairway 100 has a conventional design and construction and includes traditional balusters landings and rail walls and the like that are integrated into the structure of slide 10. For this invention, stairway 100 includes a stairway backing 110, a plurality of paired step anchors 120 affixed to the stairway backing, and a plurality of detachable step members 130 secured between the paired step anchors.

Stairway backing 110 is a length of thermoplastic covered fabrics, such as a “PVC” coated woven nylon cloth, integrated into stairway 100 as the inclined pathway to the landing of slide 10. As shown, stairway backing 110 forms the top structural panel of stairway 100, but in other embodiments, may be a separate cover sheet sewn, bonded or otherwise affixed over the top structural panel of stairway 100.

Step anchors 120 are constructed of rectangular sections of thermoplastic covered fabrics, such as a “PVC” coated woven nylon cloth. Step anchors 120 are affixed to stairway backing 110 and generally traverse the width of stairway 100. Step anchors 120 are spaced vertically apart from one another and paired together to form top and bottom anchors for detachably securing step members 130. Each step anchor 120 has an anchor base 122, which is sewn or bonded directly to stairway backing 110 and an anchor flap 124, which is adapted and constructed to fold over the anchor base. The outer face of anchor base 122 and anchor flap 124 of each step anchor 120 is covered in hook and loop fastener material 126.

Replaceable step members 130 form the steps or rungs of stairway 100. Each step member 130 has a main body 132 and pair of opposed step flanges 134 integrally extending from the opposed sides of the main body. Main body 132 is formed by a closed cell foam core 138 covered again with a thermoplastic covered fabric, such as a “PVC” coated woven nylon cloth. In other embodiments, step members 130 may be constructed from other materials, including formed or molded plastic bodies. Step flanges 134 have opposed faces covered with hook and loop fastener material 136 for mating to the hook and loop fastener material of step anchors 120.

Step members 130 are secured to stairway backing 110 between the paired step anchors 120. Step flanges 134 are interposed between anchor base 122 and anchor flaps 124, which fold back over the anchor base. The mating hook and loop fastener materials on both sides of step flanges 134 and the outer surface of the step anchors 120 securely hold step members 130 to stairway backing 110. Individual step members 130 may be removed, repaired and/or replaced, without extensive and costly repairs to stairway 100 and slide 10. The hook and loop engagement between the step members and the step anchors allows the step members to be readily detached from stairway backing 110. Manually peeling back anchor flaps 124 and step flanges 134 frees step members 130 to be manually peeled away from anchor bases 122 detaching the step members from stairway backing 110.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A stairway assembly for an inflatable structure comprising:
a stairway backing affixed to the inflatable structure;
a pair of step anchors affixed along the length of the stairway backing; and
a step member detachably mounted to the stairway back between one of the pair of step anchors.

2. The stairway assembly of claim 1 wherein each of the pair of step anchors includes a first anchor member and a second anchor member spaced from the first anchor member along the stairway backing for receiving the step member there between.

3. The stairway assembly of claim 2 wherein each of the first anchor member and the second anchor member includes an anchor base affixed to the stairway backing and an integral anchor flap that folds over the flat base part to secure the step member.

4. The stairway assembly of claim 3 wherein the step member includes a step body and a pair of step flanges extending from opposite sides of the step body.

5. The stairway assembly of claim 4 wherein the pair of step flanges is restrictively secured to and interposed between the anchor flat base and the anchor flap of the first anchor member and second anchor member when the step member is mounted to the stairway backing.

6. The stairway assembly of claim 5 wherein the pair of step flanges has opposed flange sides, each of the opposed flange sides has hook and loop fasteners mounted thereto.

7. The stairway assembly of claim 6 wherein the anchor base has hook and loop fasteners mounted thereto for mating with the hook and loop fasteners on one of the opposed flange sides of the pair of step flanges, the anchor flap has hook and loop fasteners mounted thereto for mating with the hook and loop fasteners on the other one of the opposed flange sides of the pair of step flanges.

8. A stairway assembly for an inflatable structure comprising:
a stairway backing affixed to the inflatable structure;
a plurality of paired step anchors affixed along the length of the stairway backing; and
a plurality of step members detachably mounted to the stairway backing between one of the plurality of paired step anchors,
each of the plurality of paired of step anchors includes a first anchor member and a second anchor member space from the first anchor member along the stairway backing for receiving the step member there between, each of the first anchor member and the second anchor member includes an anchor base affixed to the stairway backing and an integral anchor flap that folds over the flat base part to secure the step member,
each of the plurality of step members includes a step body and a pair of step flanges extending from opposite sides of the step body, the pair of step flanges is restrictively secured to and interposed between the anchor flat base and the anchor flap of the first anchor member and second anchor member when the plurality of step members are mounted to the stairway backing, the pair of step flanges has opposed flange sides, each of the opposed flange sides has hook and loop fasteners mounted thereto,
the anchor base has hook and loop fasteners mounted thereto for mating with the hook and loop fasteners on one of the opposed flange sides of the pair of step flanges, the anchor flap has hook and loop fasteners mounted thereto for mating with the hook and loop fasteners on the other one of the opposed flange sides of the pair of step flanges.
